(19) United States
(12) Patent Application Publication
(10) Pub. No.: US 2024/0307720 A1
(43) Pub. Date: Sep. 19, 2024

(54) PASSIVATION FIRE-EXTINGUISHING EXPLOSION-SUPPRESSION SYSTEM AND METHOD FOR LITHIUM BATTERY ENERGY STORAGE SYSTEM

(71) Applicants: State Grid Hunan Electric Power Company Limited, Changsha (CN); State Grid Hunan Electric Power company Limited Disaster Prevention And Reduction Center, Changsha (CN); State Grid Corporation of China, Beijing (CN)

(72) Inventors: Jiazheng Lu, Changsha (CN); Baohui Chen, Changsha (CN); Bo Li, Changsha (CN); Chuanping Wu, Changsha (CN); Tiannian Zhou, Changsha (CN); Yu Liu, Changsha (CN); Ping Liang, Changsha (CN)

(21) Appl. No.: 18/186,147

(22) Filed: Mar. 18, 2023

(51) Int. Cl. A62C 3/16; A62C 3/00; A62C 35/68

(52) U.S. Cl. CPC A62C 3/16; A62C 3/002; A62C 35/68; H01M 10/0525; H01M 2200/10

(57) ABSTRACT

Disclosed are a passivation fire-extinguishing explosion-suppression system and method for a lithium battery energy storage system. The passivation fire-extinguishing explosion-suppression system includes: a fire-detection sensing device configured to locate a fire location and send a fire signal, a fire-extinguishing and anti-reignition explosion-suppression device, and a controller configured to control the turn-on or turn-off of the fire-extinguishing and anti-reignition explosion-suppression device, where the fire-extinguishing and anti-reignition explosion-suppression device is configured to quickly extinguish an open flame and prevent a battery from reignition and explosion and includes a storage apparatus configured to store a fire-extinguishing and anti-reignition explosion-suppression medium; and the fire-extinguishing and anti-reignition explosion-suppression medium is a combination of 90% to 99.8% of a lithium passivation gas and 0.2% to 10% of a halohydrocarbon gas, and the lithium passivation gas is one or a combination of two selected from nitrogen and carbon dioxide.

### STATEMENT REGARDING PRIOR DISCLOSURES BY AN INVENTOR OR JOINT INVENTOR

The contents of Chinese Patent Application No. 202111460521.1 filed on Dec. 2, 2021 and published on Mar. 18, 2022, is a grace period disclosure and shall not be prior art to claimed invention.

### TECHNICAL FIELD

The present disclosure belongs to the technical field of power systems, and in particular relates to a passivation fire-extinguishing explosion-suppression system and method for a lithium battery energy storage system.

### BACKGROUND

In 2021, China put forward the grand goal of “Peak Carbon Dioxide Emissions in 2030 and Carbon Neutrality in 2060” to vigorously develop clean and low-carbon energy sources such as wind energy and photovoltaic energy. Wind and photovoltaic energy are volatile and random, requiring large-scale energy storage. Lithium battery energy storage is an important energy storage system, accounting for 92% of an installed electrochemical energy storage capacity. A cumulative installed capacity of lithium battery energy storage devices in China reached 13.6 GW as of 2020, and is expected to reach 600 GW in 2035, with a market size of more than 2 trillion.

Under an effect of a coupling of heat sources and an electrical fault such as internal and external short circuits and overcharge, lithium battery energy storage systems are prone to thermal runaway and release a large amount of heat and explosive gases, causing fire and explosion. In recent years, fire and explosion accidents in lithium battery energy storage have frequently occurred inside and outside China. Moreover, there are more than 100,000 lithium batteries in large-scale lithium battery energy storage stations, with a capacity of 10,000 kWh or more, which is much higher than a capacity of electric vehicles (usually less than 100 kWh), resulting in difficult fire-extinguishing and large hazard. The fire and explosion prevention of energy storage lithium batteries is an urgent technical problem to be solved in the field of energy storage.

Unlike conventional fire hazards, thermal runaway continues spontaneously in lithium batteries, such that it is very prone to reignition after an open flame is extinguished. A large number of chemical reactions occur inside a battery during thermal runaway to produce a large number of explosive gases, which is very easy to cause an explosion. Conventional fire-extinguishing techniques are difficult to quickly extinguish an open flame of a battery, cannot block a chemical reaction inside a battery, and are also difficult to absorb a large amount of heat generated due to thermal runaway of a battery, such that it is difficult to suppress reignition and explosion. Currently, water, heptafluoropropane, and perfluorohexanone fire-extinguishing systems are mainly used in fire-extinguishing for energy storage lithium batteries. The water fire-extinguishing system adopts water to extinguish a fire, where water conducts electricity, and the water is released to a battery and an electrical device to cause a short circuit in the device. Heptafluoropropane and perfluorohexanone fire-extinguishing agents have poor cooling performance, cannot inhibit the reignition caused by thermal runaway of a lithium battery, and cannot inhibit the battery explosion.

### SUMMARY

A main objective of the present disclosure is to provide a passivation fire-extinguishing explosion-suppression system and method for a lithium battery energy storage system, and the present disclosure is intended to solve the technical problem that the fire-extinguishing systems in the prior art are difficult to quickly extinguish an open flame and are also difficult to suppress reignition and explosion.

In order to achieve the above objective, the present disclosure provides a passivation fire-extinguishing explosion-suppression system for a lithium battery energy storage system, including:
a fire-detection sensing device configured to detect and locate a fire location in an energy storage battery compartment and send a fire signal;
a fire-extinguishing and anti-reignition explosion-suppression device configured to quickly extinguish an open flame and prevent a battery from reignition and explosion, where the fire-extinguishing and anti-reignition explosion-suppression device includes a storage apparatus configured to store a fire-extinguishing and anti-reignition explosion-suppression medium; and the fire-extinguishing and anti-reignition explosion-suppression medium is a combination of 90% to 99.8% of a lithium passivation gas and 0.2% to 10% of a halohydrocarbon gas, and the lithium passivation gas is one or a combination of two selected from nitrogen and carbon dioxide; and
a controller in communication with the fire-detection sensing device and configured to:
receive the fire signal sent by the fire-detection sensing device and
control the turn-on or turn-off of the fire-extinguishing and anti-reignition explosion-suppression device according to the fire signal.

In an embodiment of the present disclosure, the halohydrocarbon gas is a halohydrocarbon with two or more halogens.

In an embodiment of the present disclosure, the halohydrocarbon gas is one or a combination of two or more selected from the group consisting of CBrF═CF₂, CHF₃, CF₂═CHCF₃, CF₂═CFCF₃, CClF═CF₂, CF₃—S—CF₃, CF₃CN, CH₂═CHCF₃, CF₂═CF₂, CF₂═CHF, CH₂═CF₂, CCl₃F, CCl₂F₂, CHClF₂, CF₃I, CF₃Br, CH₂═CHBr, and N(CF₃)₃.

In an embodiment of the present disclosure, the fire-extinguishing and anti-reignition explosion-suppression device is connected to a battery module through a connecting pipeline; the battery module includes a plurality of energy storage battery compartments stacked from top to bottom; the connecting pipeline has one end communicating with a main pipeline and the other end communicating with a plurality of branch pipelines; the plurality of branch pipelines extend into tops of the plurality of energy storage battery compartments in a one-to-one correspondence manner; and an outlet of each of the plurality of branch pipelines is provided with a nozzle configured to spray the fire-extinguishing and anti-reignition explosion-suppression medium on the plurality of energy storage battery compartments.

In an embodiment of the present disclosure, the main pipeline is provided successively with a turn-on control valve, a one-way flow valve, and a selection valve along a flow direction of the fire-extinguishing and anti-reignition explosion-suppression medium.

In an embodiment of the present disclosure, the fire-detection sensing device includes one or a combination of two or more selected from the group consisting of a smoke-sensing component configured to detect a smoke, a temperature-sensing component configured to monitor a temperature, a combustible gas-detecting component configured to monitor a combustible gas, and a deformation-detecting component configured to monitor a deformation amount of a battery case.

In an embodiment of the present disclosure, the combustible gas is one or a combination of two or more selected from the group consisting of H₂, CO, CO₂, CH₄, C₂H₄, SO₂, C₂H₆, and C₃H₆.

In an embodiment of the present disclosure, the fire-extinguishing and anti-reignition explosion-suppression medium has a storage temperature ranging from −30° C. to 20° C.

In an embodiment of the present disclosure, the fire-extinguishing and anti-reignition explosion-suppression medium has a storage pressure ranging from 1 MPa to 10 MPa.

The present disclosure also provides a passivation fire-extinguishing explosion-suppression method for a lithium battery energy storage system used in the passivation fire-extinguishing explosion-suppression system for a lithium battery energy storage system described above, including:
acquiring a fire signal and locating a fire location; and
turning on the fire-extinguishing and anti-reignition explosion-suppression device according to the fire signal, and starting fire extinguishing.

Through the above technical solutions, the passivation fire-extinguishing explosion-suppression system for a lithium battery energy storage system provided by the embodiments of the present disclosure has the following beneficial effects:

When the fire-detection sensing device detects that a fire occurs in a lithium battery energy storage system and a fire location is located, the controller controls the turn-on of the fire-extinguishing and anti-reignition explosion-suppression device. In the present disclosure, N₂ and CO₂ in the fire-extinguishing and anti-reignition explosion-suppression medium are used as lithium passivation gases in combination with the high-efficiency halohydrocarbon gas fire-extinguishing medium including two or more halogens in the fire-extinguishing and anti-reignition explosion-suppression medium to achieve the fire extinguishing for a lithium battery. Specifically, the high-efficiency halohydrocarbon gas fire-extinguishing medium is used to extinguish an open flame quickly, and the lithium passivation gas is used to passivate active lithium, dilute an explosive gas to inhibit the generation of flammable and explosive gases, and inhibit the thermal runaway and thermal spread of a lithium battery, thereby terminating the fire and explosion of the lithium battery and realizing the three functions of rapid fire extinguishing, reignition prevention, and explosion suppression. In addition, the fire-extinguishing system is simple, easy to implement, and suitable for large-scale promotion and application.

Other features and advantages of the present disclosure are described in detail in the following DETAILED DESCRIPTION part.

### BRIEF DESCRIPTION OF THE DRAWINGS

The accompanying drawings are provided for further understanding of the present disclosure, and constitute a part of the specification. The accompanying drawings and the detailed description below are intended to explain the present disclosure, rather than to limit the present disclosure. In the accompanying drawings:

FIG. 1 is a schematic structural diagram of a passivation fire-extinguishing explosion-suppression system for a lithium battery energy storage system according to an embodiment of the present disclosure; and

FIG. 2 is a schematic structural diagram of a passivation fire-extinguishing explosion-suppression system for a lithium battery energy storage system according to an embodiment of the present disclosure in a simulation contrast test device.

### REFERENCE NUMERALS

10: fire-detection sensing device; 20: controller; 30: energy storage battery compartment; 40: fire-extinguishing and anti-reignition explosion-suppression device; 50: connecting pipeline; 51: branch pipeline; 52: nozzle; 60: turn-on control valve; 61: one-way flow valve; and 62: selection valve.

### DETAILED DESCRIPTION

The specific embodiments of the present disclosure are described in detail below with reference to the accompanying drawings. It should be understood that the specific embodiments described herein are merely intended to illustrate and explain the present disclosure, rather than to limit the present disclosure.

The passivation fire-extinguishing explosion-suppression system for a lithium battery energy storage system according to the present disclosure is described below with reference to the accompanying drawings.

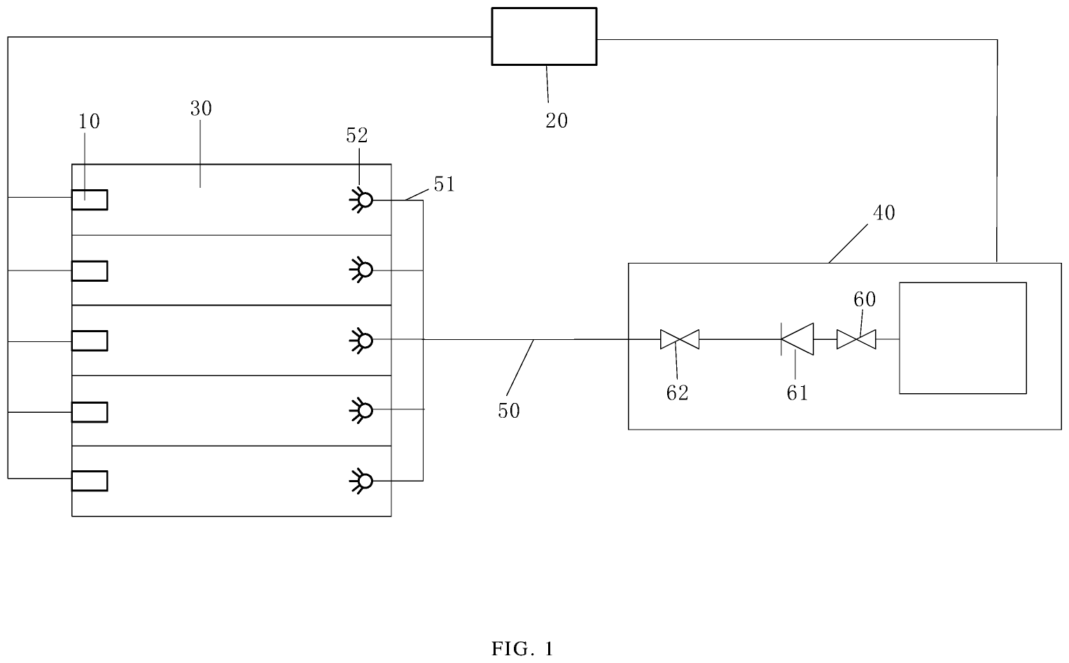

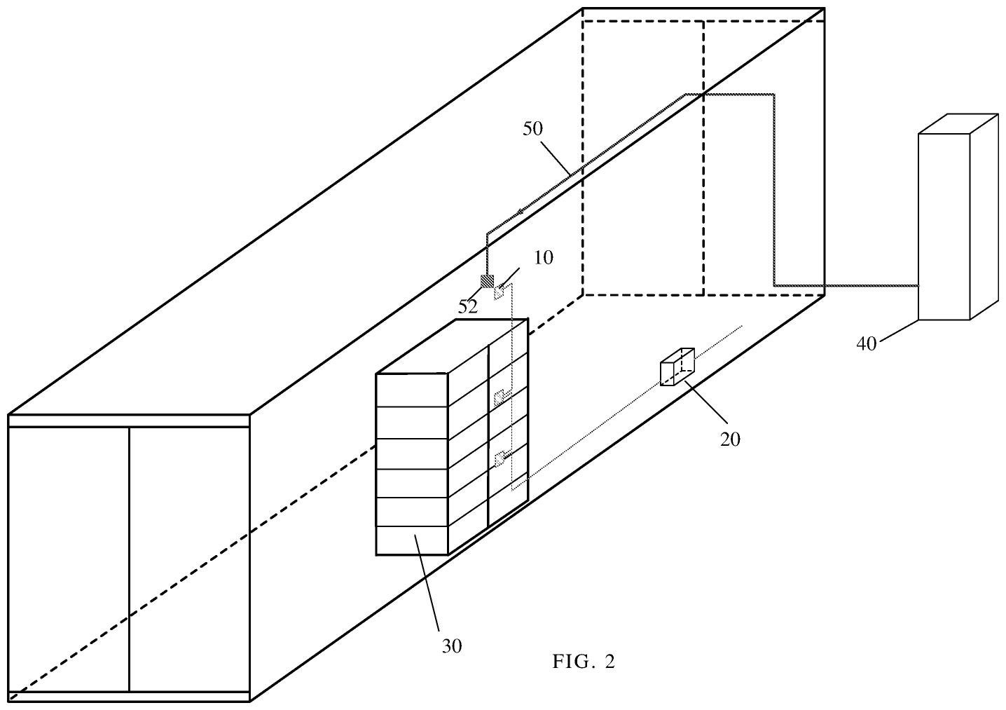

As shown in FIG. 1 and FIG. 2, in an embodiment of the present disclosure, a passivation fire-extinguishing explosion-suppression system for a lithium battery energy storage system is provided, including:
a fire-detection sensing device 10 configured to detect and locate a fire location in an energy storage battery compartment 30 and send a fire signal;
a fire-extinguishing and anti-reignition explosion-suppression device 40 configured to quickly extinguish an open flame and prevent a battery from reignition and explosion, where the fire-extinguishing and anti-reignition explosion-suppression device 40 includes a storage apparatus configured to store a fire-extinguishing and anti-reignition explosion-suppression medium; and the fire-extinguishing and anti-reignition explosion-suppression medium is a combination of 90% to 99.8% of a lithium passivation gas and 0.2% to 10% of a halohydrocarbon gas, and the lithium passivation gas is one or a combination of two selected from nitrogen and carbon dioxide; and
a controller 20 in communication with the fire-detection sensing device 10 and configured to:
receive the fire signal sent by the fire-detection sensing device 10 and
control the turn-on or turn-off of the fire-extinguishing and anti-reignition explosion-suppression device 40 according to the fire signal.

When a lithium-ion battery (LIB) undergoes thermal runaway and catches fire, a combustible substance in the battery is ejected at high speed through an exhaust valve of the battery itself, and quickly spreads to other batteries in the same module and cluster within a few seconds, such that the fire is expanded and difficult to control. Therefore, after an open flame occurs in an energy storage lithium battery, the efficient and quick fire-extinguishing is required to prevent the spread of the fire. The extinguishing of an open flame in an LIB within 5 s can ensure a prominent fire spread-preventing effect.

Moreover, the thermal runaway fire of a lithium battery produces a huge amount of heat. The heat generated by thermal runaway of a 100 Ah lithium battery with a weight of about 1.4 Kg can be equivalent to the heat generated by an explosion reaction of a 212 g TNT explosive. A battery compartment includes 5,000 or more cells, and produces a very large amount of heat. The traditional fire-extinguishing techniques can only extinguish an initial open flame of a lithium battery through physical asphyxiation and chemical principles such as capturing and combustion of free radicals, which cannot consume the heat generated by thermal runaway of the lithium battery as much as possible and cannot completely inhibit the thermal runaway caused by internal chemical reactions of the lithium battery, such that the lithium battery is very prone to reignition. Therefore, the fire of an energy storage lithium battery needs to be extinguished by an anti-reignition fire-extinguishing method that can absorb a large amount of heat generated by thermal runaway of the battery.

In addition, a battery includes a large number of active lithium substances, and chain chemical reactions cause the rapid decomposition of electrodes, an electrolyte, a separator, and a binder in the battery to produce a large number of explosive gases. The explosive gases include hydrogen, carbon monoxide, and ethylene. The traditional fire-extinguishing techniques cannot inhibit the explosion of combustible gases, and thus it is necessary to provide a technique and method for explosion suppression of fire of an energy storage lithium battery.

In view of the above problems, the inventors analyze a thermal runaway process of a lithium battery, and then a large number of tests and theoretical studies are conducted. Results show that the large amount of active lithium in a lithium battery and the large amount of heat generated by thermal runaway are the reasons why the spread of thermal runaway of the battery is difficult to suppress. Active lithium in a battery includes a lithium metal element and lithium LiC_{X} embedded in a negative electrode of the battery. When a lithium battery works normally, active lithium is inside the battery, and structures such as a battery separator and electrodes are intact and are not in contact with the outside, such that the battery can operate stably. When a battery undergoes thermal runaway, a separator melts, positive and negative electrodes of the battery undergo short circuits, an exhaust valve opens, and substances inside the battery are exposed to the outside air. As a result, the active lithium in the battery can react with the electrolyte in the battery (ethylene carbonate (EC), propylene carbonate (PC), and dimethyl carbonate (DMC)) to release a large amount of heat and combustible gases such as ethylene, ethane, and propylene, for example:

2Li+C₃H₄O₃ (EC)→Li₂CO₃+C₂H₄;

2Li+C₄H₆O₃ (PC)→Li₂CO₃+C₃H₆; and

2Li+C₃H₆O₃ (DMC)→Li₂CO₃+C₂H₆.

The active lithium can also react with the binder (polyvinylidene fluoride (PVDF), cellulose, or the like) of the battery to produce heat and flammable and explosive gases:

CMC-OH (cellulose)+Li→CMC-OLi+H₂ and

—CH₂—CF₂— (PVDF)+Li→LiF+—CH═CF—+H₂.

Therefore, the consumption of active lithium is an effective way to inhibit the thermal runaway of a battery. The inventors propose a method in which a large number of gases capable of reacting with active lithium are used to passivate active lithium in a lithium battery, which can effectively inhibit the thermal runaway of the battery and inhibit the generation of flammable and explosive gases. The lithium passivation gas proposed by the inventors is one or a combination of two selected from N₂ and CO₂. The main passivation reactions are as follows:

N₂+LiCₓ→Li₃N+C;

Li+N₂→Li₃N;

Li+CO₂→Li₂CO₃+C; and

CO₂+LiCₓ→Li₂CO₃+C.

The adopted gas for passivating active lithium has a high diffusion rate, such that the heat and flammable and explosive gases generated due to chemical reactions inside a battery can be taken away through the diffusion of the gas, thereby inhibiting the thermal runaway of the battery. In addition, in order to improve an ability of the gas to take away heat, a storage temperature of the lithium passivation gas is preferably reduced to below room temperature.

However, the lithium passivation gas has a poor ability to extinguish an open flame of a battery. Therefore, the inventors further propose a method of mixing a halohydrocarbon gas with the lithium passivation gas, where halogens included in the halohydrocarbon gas can absorb combustion free radicals such as H, O, and C and quickly extinguish an open flame.

Since the halohydrocarbon gas includes two or more halogens, the different halogens can produce a synergistic flame-retardant effect. A principle of the synergistic flame-retardant effect can be as follows: The different halogens have different flame-retardant mechanisms in different temperature ranges and play a synergistic flame-retardant role during combustion to reduce the combustion heat of combustibles, such that a fire-extinguishing agent exhibits improved fire-extinguishing performance and can quickly extinguish an open flame of a lithium battery at a low concentration, and the economy of the fire-extinguishing method is significantly improved.

Based on the above characteristics, a fire-extinguishing scheme of the passivation fire-extinguishing explosion-suppression system for a lithium battery energy storage system proposed by the inventors is as follows: N₂ and CO₂ are used as lithium passivation gases in combination with the high-efficiency halohydrocarbon gas fire-extinguishing medium including two or more halogens to achieve the fire extinguishing for a lithium battery. The high-efficiency halohydrocarbon gas fire-extinguishing medium is used to quickly extinguish an open flame, and the lithium passivation gas is used to passivate active lithium, dilute an explosive gas to inhibit the generation of flammable and explosive gases from preventing explosion, and inhibit the thermal runaway and thermal spread of a lithium battery, thereby terminating the fire and explosion of the lithium battery.

In an embodiment of the present disclosure, the halohydrocarbon gas is a halohydrocarbon with two or more halogens.

Preferably, the halohydrocarbon gas is one or a combination of two or more selected from the group consisting of CBrF═CF₂, CHF₃, CF₂═CHCF₃, CF₂═CFCF₃, CClF═CF₂, CF₃—S—CF₃, CF₃CN, CH₂═CHCF₃, CF₂═CF₂, CF₂═CHF, CH₂═CF₂, CCl₃F, CCl₂F₂, CHClF₂, CF₃I, CF₃Br, CH₂═CHBr, and N(CF₃)₃.

In an embodiment of the present disclosure, the fire-extinguishing and anti-reignition explosion-suppression device 40 is connected to a battery module through a connecting pipeline 50; the battery module includes a plurality of energy storage battery compartments 30 stacked from top to bottom; the connecting pipeline 50 has one end communicating with a main pipeline and the other end communicating with a plurality of branch pipelines 51; the plurality of branch pipelines 51 extend into tops of the plurality of energy storage battery compartments 30 in a one-to-one correspondence manner; and an outlet of each of the plurality of branch pipelines 51 is provided with a nozzle 52 configured to spray the fire-extinguishing and anti-reignition explosion-suppression medium on the plurality of energy storage battery compartments 30. When the fire-extinguishing and anti-reignition explosion-suppression device 40 is turned on, each nozzle 52 sprays the fire-extinguishing and anti-reignition explosion-suppression medium into a corresponding energy storage battery compartment 30 to extinguish fire of the energy storage battery compartment 30, which can ensure a fire-extinguishing range of the energy storage battery compartment 30.

In an embodiment of the present disclosure, the main pipeline is provided successively with a turn-on control valve 60, a one-way flow valve 61, and a selection valve 62 along a flow direction of the fire-extinguishing and anti-reignition explosion-suppression medium. When a lithium battery catches fire, after the fire-detection sensing device 10 detects a fire signal, the fire-extinguishing and anti-reignition explosion-suppression device 40 is turned on by the controller 20, and the fire-extinguishing and anti-reignition explosion-suppression medium flows from the storage device into the plurality of branch pipelines 51 through the turn-on control valve 60, the selection valve 62, the one-way flow valve 61, and the connecting pipeline 50; and a nozzle 52 is provided at an outlet of each branch pipeline 51, and the fire-extinguishing and anti-reignition explosion-suppression medium is sprayed through the nozzle 52 to a corresponding energy storage battery compartment 30 for fire extinguishing. In this embodiment, the nozzle 52 is provided in each energy storage battery compartment 30, such that the fire extinguishing can be conducted accurately for each energy storage battery compartment 30 in real time.

In an embodiment of the present disclosure, the fire-detection sensing device 10 includes one or a combination of two or more selected from the group consisting of a smoke-sensing component configured to detect a smoke, a temperature-sensing component configured to monitor a temperature, a combustible gas-detecting component configured to monitor a combustible gas, and a deformation-detecting component configured to monitor a deformation amount of a battery case. The combustible gas-detecting component can detect H₂, CO, and CH₄ simultaneously.

In an embodiment of the present disclosure, the combustible gas is one or a combination of two or more selected from the group consisting of H₂, CO, CO₂, CH₄, C₂H₄, SO₂, C₂H₆, and C₃H₆, where H₂, CO, CO₂, and CH₄ are preferably detected.

In an embodiment of the present disclosure, the fire-extinguishing and anti-reignition explosion-suppression medium has a storage temperature ranging from −30° C. to 20° C. and preferably −20° C. to 0° C.

In an embodiment of the present disclosure, the fire-extinguishing and anti-reignition explosion-suppression medium has a storage pressure ranging from 1 MPa to 10 MPa.

The present disclosure also provides a passivation fire-extinguishing explosion-suppression method for a lithium battery energy storage system used in the passivation fire-extinguishing explosion-suppression system for a lithium battery energy storage system described above, including:
acquiring a fire signal and locating a fire location; and
turning on the fire-extinguishing and anti-reignition explosion-suppression device 40 according to the fire signal, and starting fire extinguishing.

When a fire signal is acquired, it is determined whether fire actually occurs. If the fire actually occurs, the fire-extinguishing and anti-reignition explosion-suppression device 40 is turned on, and fire extinguishing is started. In the present disclosure, the halohydrocarbon gas in the high-efficiency fire-extinguishing and anti-reignition explosion-suppression medium of the present disclosure can quickly extinguish an initial open flame and quickly prevent the spread of the open flame.

In the present disclosure, the lithium passivation medium in the high-efficiency fire-extinguishing and anti-reignition explosion-suppression medium can passivate an active lithium substance, absorb heat for cooling, and inhibit the generation of flammable and explosive gases. In addition, the gas for passivating active lithium has excellent diffusion, and can deeply passivate active lithium and cool a battery with high heat transfer efficiency, which can effectively inhibit the thermal runaway and completely eliminate the spread of thermal runaway. The fire-extinguishing method and device are simple and easy to implement, can realize the three functions of efficient fire extinguishing, anti-reignition, and explosion suppression, and are suitable for large-scale promotion and application; and the system structure has excellent stability and economy.

In order to further illustrate the advantages of the system, in the present disclosure, two fire-extinguishing and anti-reignition explosion-suppression media and three ordinary fire-extinguishing media each are preferably used to conduct a fire-extinguishing experiment in a same operating environment, and a fire-extinguishing speed is observed.

Example 1: A combination of 98% of a lithium passivation gas and 2% of a halohydrocarbon gas is adopted as a fire-extinguishing and anti-reignition explosion-suppression medium. Preferably, the lithium passivation gas is a mixture of 40% of N₂ and 60% of CO₂. The halohydrocarbon gas is CBrF═CF₂. The high-efficiency fire-extinguishing and anti-reignition explosion-suppression medium has a storage temperature of −10° C. and a storage pressure of 4.0 MPa. The fire-extinguishing and anti-reignition explosion-suppression medium gas is stored in a storage tank, and the storage tank is cooled by a cooling system and placed at −10° C. for a long time.

Example 2: A combination of 98% of a lithium passivation gas and 2% of a halohydrocarbon gas is adopted as a fire-extinguishing and anti-reignition explosion-suppression medium. Preferably, the lithium passivation gas is a mixture of 40% of N₂ and 60% of CO₂. The halohydrocarbon gas is a mixed gas of CF₂═CHCF₃ and CF₃Br, where CF₂═CHCF₃ and CF₃Br each account for 50%. The present disclosure is used in the protection of a lithium battery energy storage system; and the lithium battery energy storage system includes a plurality of battery clusters, each of the plurality of battery clusters includes a plurality of battery cabinets, and each of the plurality of battery cabinets includes a plurality of battery modules, where the battery modules are the smallest units in the protection by the fire-extinguishing system of the present disclosure.

In Examples 1 and 2, when a lithium battery catches fire, after the fire-detection sensing device 10 detects a fire signal, the high-efficiency fire-extinguishing and anti-reignition explosion-suppression device 40 is turned on by the controller 20, and the high-efficiency fire-extinguishing and anti-reignition explosion-suppression medium is sprayed from the high-efficiency fire-extinguishing and anti-reignition explosion-suppression medium storage device through the high-efficiency fire-extinguishing and anti-reignition explosion-suppression medium storage device turn-on valve, the high-efficiency fire-extinguishing and anti-reignition explosion-suppression medium selection valve 62, the high-efficiency fire-extinguishing and anti-reignition explosion-suppression medium one-way valve, the main pipeline, the branch pipeline 51, and the nozzle 52 arranged in the lithium battery energy storage compartment for fire extinguishing. The high-efficiency fire-extinguishing and anti-reignition explosion-suppression medium can quickly extinguish an open flame of a battery, passivate active lithium, and absorb a large amount of heat; and when filled in the energy storage battery compartment 30, the gas can dilute flammable and explosive gases to avoid gas explosion, thereby realizing the three functions of rapid fire extinguishing, reignition prevention, and explosion suppression.

In order to further illustrate the rapid fire extinguishing of the fire-extinguishing and anti-reignition explosion-suppression medium of the present disclosure, under the same operating conditions and with the same experimental devices, an ordinary fire-extinguishing medium is used instead of the fire-extinguishing and anti-reignition explosion-suppression medium for fire extinguishing. The inventors adopt the following three comparative examples, and fire-extinguishing speeds of the examples are compared with fire-extinguishing speeds of the comparative examples.

Comparative Example 1: 100% of a lithium passivation gas is adopted as a fire-extinguishing medium. Preferably, the lithium passivation gas is a mixture of 40% of N₂ and 60% of CO₂.

Comparative Example 2: A combination of 98% of a lithium passivation gas and 2% of a halohydrocarbon gas is adopted as a fire-extinguishing medium. Preferably, the lithium passivation gas is a mixture of 40% of N₂ and 60% of CO₂. The halohydrocarbon gas is CF₂═CHCF₃.

Comparative Example 3: A combination of 98% of a lithium passivation gas and 2% of a halohydrocarbon gas is adopted as a fire-extinguishing medium.

Preferably, the lithium passivation gas is a mixture of 40% of N₂ and 60% of CO₂. The halohydrocarbon gas is CF₃Br.

The simulation contrast test device in FIG. 2 is used to conduct contrast tests of Examples 1 and 2 and Comparative Examples 1 to 3. A test method is as follows: An LIB module (with a power of 1.2 kWh) is fixed in an intermediate layer of a shelf of a fire-extinguishing test chamber for a container-type energy storage system. A method mode of heating a battery is adopted to trigger the thermal runaway of the battery. When a battery catches fire, a heating device is turned off. When the fire-detection sensing device 10 detects fire, the fire-extinguishing system is turned on to extinguish fire, with a fire-extinguishing flow rate of 8 m³/h. Fire-extinguishing times are compared. Contrast test results are as follows:

| | | | Compar- | Compar- | Compar- |
|---|---|---|---|---|---|
| | | | ative | ative | ative |
| | Exam- | Exam- | Exam- | Exam- | Exam- |
| Sample | ple 1 | ple 2 | ple 1 | ple 2 | ple 3 |
| Fire- | 4 | 4 | 25 | 12 | 11 |
| extinguishing | | | | | |
| time (s) | | | | | |

It can be seen from the contrast test results that the halohydrocarbon fire-extinguishing gas with two or more halogens has the highest fire-extinguishing speed; the halohydrocarbon fire-extinguishing gas with only a single halogen has a significantly-reduced fire-extinguishing speed and cannot extinguish an open flame of a battery within 5 s; and when only the lithium passivation gas is adopted, the fire-extinguishing speed is the slowest, and a long fire-extinguishing time is required, which further verifies the rapidity and reliability of the fire-extinguishing and anti-reignition explosion-suppression medium of the present disclosure.

It should be understood that in the description of the present disclosure, terms such as “first” and “second” are used merely for the purpose of description, and should not be construed as indicating or implying relative importance, or implicitly indicating the number of technical features denoted. Therefore, features defined by “first” and “second” may explicitly or implicitly include at least one of the features. In description of the present disclosure, “a plurality of” means at least two, such as two or three, unless otherwise clearly and specifically limited.

In the present disclosure, unless otherwise clearly specified and limited, the terms “installation”, “interconnection”, “connection”, “fixation”, or the like should be understood in a broad sense. For example, the “connection” may be a fixed connection, a removable connection, or an integral connection; may be a mechanical connection, an electrical connection, or an intercommunication; may be a direct connection or an indirect connection through an intermedium; and may be a communication or an interaction between two elements, unless otherwise clearly limited. Those of ordinary skill in the art may understand specific meanings of the above terms in the present disclosure based on a specific situation.

In this specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without any contradiction.

Although the embodiments of the present disclosure have been illustrated and described above, it will be appreciated that the above embodiments are illustrative and should not be construed as limiting the present disclosure. Changes, modifications, substitutions, and variations can be made to the above embodiments by a person of ordinary skill in the art within the scope of the present disclosure.

1. A passivation fire-extinguishing explosion-suppression system for a lithium battery energy storage system, comprising:
a fire-detection sensing device (10) configured to detect and locate a fire location in an energy storage battery compartment (30) and send a fire signal;
a fire-extinguishing and anti-reignition explosion-suppression device (40) configured to quickly extinguish an open flame and prevent a battery from reignition and explosion, wherein the fire-extinguishing and anti-reignition explosion-suppression device (40) comprises a storage apparatus configured to store a fire-extinguishing and anti-reignition explosion-suppression medium; and the fire-extinguishing and anti-reignition explosion-suppression medium is a combination of 90% to 99.8% of a lithium passivation gas and 0.2% to 10% of a halohydrocarbon gas, and the lithium passivation gas is one or a combination of two selected from nitrogen and carbon dioxide; and
a controller (20) in communication with the fire-detection sensing device (10) and configured to:
receive the fire signal sent by the fire-detection sensing device (10) and
control the turn-on or turn-off of the fire-extinguishing and anti-reignition explosion-suppression device (40) according to the fire signal.

2. The passivation fire-extinguishing explosion-suppression system for a lithium battery energy storage system according to claim 1, wherein the halohydrocarbon gas is a halohydrocarbon with two or more halogens.

3. The passivation fire-extinguishing explosion-suppression system for a lithium battery energy storage system according to claim 1, wherein the halohydrocarbon gas is one or a combination of two or more selected from the group consisting of CBrF═CF₂, CHF₃, CF₂═CHCF₃, CF₂═CFCF₃, CClF═CF₂, CF₃—S—CF₃, CF₃CN, CH₂═CHCF₃, CF₂═CF₂, CF₂═CHF, CH₂═CF₂, CCl₃F, CCl₂F₂, CHClF₂, CF₃I, CF₃Br, CH₂═CHBr, and N(CF₃)₃.

4. The passivation fire-extinguishing explosion-suppression system for a lithium battery energy storage system according to claim 1, wherein the fire-extinguishing and anti-reignition explosion-suppression device (40) is connected to a battery module through a connecting pipeline (50); the battery module comprises a plurality of energy storage battery compartments (30) stacked from top to bottom; the connecting pipeline (50) has one end communicating with a main pipeline and the other end communicating with a plurality of branch pipelines (51); the plurality of branch pipelines (51) extend into tops of the plurality of energy storage battery compartments (30) in a one-to-one correspondence manner; and an outlet of each of the plurality of branch pipelines (51) is provided with a nozzle (52) configured to spray the fire-extinguishing and anti-reignition explosion-suppression medium on the plurality of energy storage battery compartments (30).

5. The passivation fire-extinguishing explosion-suppression system for a lithium battery energy storage system according to claim 4, wherein the main pipeline is provided successively with a turn-on control valve (60), a one-way flow valve (61), and a selection valve (62) along a flow direction of the fire-extinguishing and anti-reignition explosion-suppression medium.

6. The passivation fire-extinguishing explosion-suppression system for a lithium battery energy storage system according to claim 1, wherein the fire-detection sensing device (10) comprises one or a combination of two or more selected from the group consisting of a smoke-sensing component configured to detect a smoke, a temperature-sensing component configured to monitor a temperature, a combustible gas-detecting component configured to monitor a combustible gas, and a deformation-detecting component configured to monitor a deformation amount of a battery case.

7. The passivation fire-extinguishing explosion-suppression system for a lithium battery energy storage system according to claim 6, wherein the combustible gas is one or a combination of two or more selected from the group consisting of H₂, CO, CO₂, CH₄, C₂H₄, SO₂, C₂H₆, and C₃H₆.

8. The passivation fire-extinguishing explosion-suppression system for a lithium battery energy storage system according to claim 1, wherein the fire-extinguishing and anti-reignition explosion-suppression medium has a storage temperature ranging from −30° C. to 20° C.

9. The passivation fire-extinguishing explosion-suppression system for a lithium battery energy storage system according to claim 1, wherein the fire-extinguishing and anti-reignition explosion-suppression medium has a storage pressure ranging from 1 MPa to 10 MPa.

10. A passivation fire-extinguishing explosion-suppression method for a lithium battery energy storage system used in the passivation fire-extinguishing explosion-suppression system for a lithium battery energy storage system according to claim 1, comprising:
acquiring a fire signal and locating a fire location; and
turning on the fire-extinguishing and anti-reignition explosion-suppression device (40) according to the fire signal, and starting fire extinguishing.
